(19) United States
(12) Patent Application Publication
(10) Pub. No.: US 2007/0001820 A1
(43) Pub. Date: Jan. 4, 2007

(54) Electronic device having capability for providing reminder alerts and method therefor

(76) Inventor: Guo Wen Luo, Grayslake, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/171,606

(22) Filed: Jun. 30, 2005

(51) Int. Cl. G08B 1/00

(52) U.S. Cl. 340/309.7

(57) ABSTRACT

An electronic device (100) including a method to provide a reminder alert is disclosed herein. The method includes the steps of storing one or more MPEG Audio Layer 3 (MP3) or MP4 files in a memory (105) of the electronic device(100), setting a MP3/MP4 file as the reminder alert; and activating the reminder alert in response to a missed event.

### FIELD OF INVENTION

The present invention relates generally to electronic devices. More particularly, the present invention relates to an electronic device having the capability to provide a reminder alert and a method of operation therefore.

### BACKGROUND

In some existing electronic devices, when a communication call is received but not answered, a missed call notification is activated. The missed call notification, for example, can be a missed call dialog displayed on a display, an audible alert, a vibratory alert, or any combination thereof. Further, the electronic device can display, along with the missed call notification, information about the missed call in a text format, which can be viewed by the user later.

Many electronic devices today include the capability to schedule events and set calendar reminders for the same. As with a missed called, a calendar event can be missed by the user resulting in a missed event.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary configuration of a system for providing a reminder alert for a missed event in accordance with an embodiment of the invention.

FIG. 2 illustrates an exemplary flowchart of a method for enabling an electronic device to provide a reminder alert for a missed event in accordance with an embodiment of the invention.

FIG. 3 illustrates an exemplary flowchart of a method for enabling electronic device to provide a reminder alert for a missed event in accordance with an embodiment of the invention, wherein the missed event is a missed call.

FIG. 4 illustrates an exemplary flowchart of a method for enabling electronic device to provide a reminder alert for a missed event in accordance with an embodiment of the invention, wherein the missed event is a missed calendar event.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In this document the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Before describing in detail the electronic device having capability for providing reminder alerts and method therefore in accordance with the present invention, it should be observed that the present invention resides primarily in combination of method steps and device components related to providing a reminder alert in an electronic device. Accordingly the device components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

As stated earlier, some electronic devices provide a message reminder alert. One disadvantage to traditional message reminder alerting mechanisms is the need for the user of the electronic device to view a display of the electronic device to know of the message reminder alert. Therefore, there exists a higher probability that the user would not be well informed about the missed event immediately after the occurrence of the missed event. The present invention relates generally to a method to provide a reminder alert in an electronic device for missed events. Specifically, the present invention provides a method and system for utilizing one or more MPEG (Motion Pictures Experts Group) Audio Layer 3 (MP3) or MP4 files as a reminder alert in an electronic device. By using one or more MP3/MP4 files as a reminder, the user would be well informed and this would facilitate early attention to a missed event. The compact size of MP3/MP4 files facilitates memory storage as well.

It will be appreciated by those of ordinary skill in the art that, in accordance with the present invention, an electronic device can be a communication device, a mobile telephone, a laptop computer, a personal computer, a personal digital assistant, or an equivalent.

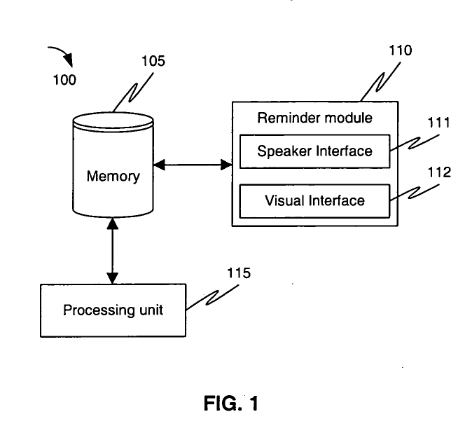

Referring to FIG. 1, an exemplary configuration 100 of a system within an electronic device for providing reminder alerts for missed events in accordance with an embodiment of the invention is illustrated. The system 100 comprises a memory 105 for storing one or more MPEG Audio Layer 3 (MP3) or MP4 files. The MP3/MP4 files stored in the memory 105 can be associated with one or more missed events. The system 100 further comprises a reminder module 110, which comprises a speaker interface 111 and a visual interface 112. A processing unit 115 is coupled to the memory 105 and the reminder module 110. The processing unit 115 can enable identification of a missed event. After identifying the missed event, the processing unit 115 can retrieve a MP3/MP4 file associated with the missed event from the memory 105 and can further activate a reminder alert that includes the retrieved MP3/MP4 file. Since the reminder alert includes the MP3/MP4 file, the speaker interface 111 forming part of the reminder module 110 is activated to play the MP3/MP4 file in order to notify a user. The visual interface 112 forming part of the reminder module 110 enables display of one or more settings during configuration or otherwise. The settings can comprise selecting and assigning a particular MP3/MP4 file to a missed call reminder for a user. Once the settings are configured, in the event of having a missed call, the particular MP3/MP4 file would be played periodically according to the settings until a user input is received, which in turn ensures that the user has become aware of the missed call. The user may also configure the settings such that the reminder can be provided for a predetermined quantity of repetitions. Therefore the reminder may be played at a predetermined time interval, for a predetermined period of time, and for a predetermined quantity of repetitions. Those skilled in the art will appreciate that the reminder may stop also on a battery of the electronic device being exhausted, or on the electronic device being switched off.

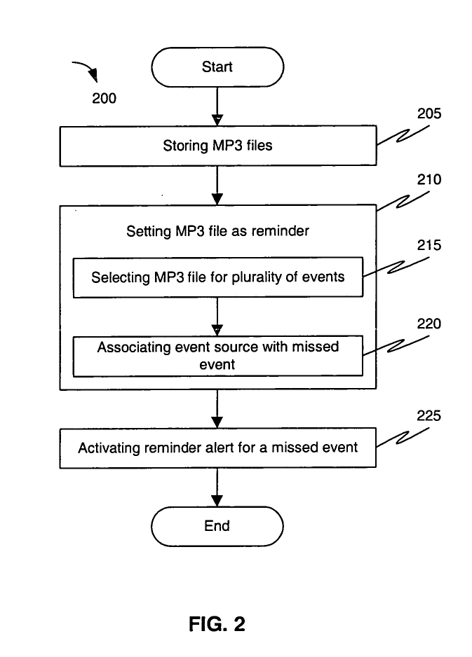

Referring to FIG. 2, a flow diagram 200, in accordance with an embodiment of the invention, for enabling an electronic device to provide a reminder alert for a missed event wherein the missed event can be a missed call or a missed calendar event is illustrated. The missed call can be, for example, a call that has been unanswered. The missed calendar event can be, for example, a task for which a reminder has been set. The missed calendar event can include an appointment, a meeting, a teleconference and the like. The operation 200 comprises, at step 205, storing one or more MPEG Audio Layer 3 (MP3) or MP4 files in a memory 105 of the electronic device. Next, at step 210, the embodiment further comprises setting of the MP3/MP4 file as a reminder alert. The processing unit 115 enables the setting of the MP3/MP4 file as the reminder alert. The step 210 of setting one of the one or more MP3/MP4 files for each of the plurality of event sources can comprise, at step 215, selecting one of the one or more MP3/MP4 files for each of the plurality of event sources and at step 220 associating an event source with the missed event, wherein the reminder alert is set to the MP3/MP4 file associated with the event source. In an embodiment of the invention wherein the missed event is a missed call, the event source can be selected from a group comprising a caller of the missed call, a source identification of the missed call, a telephone number of the missed call, a category of the missed call, and a category of a call source. In another embodiment of the invention wherein the missed event is a missed calendar event, the event source can be selected from a group comprising a calendar event organizer, a calendar event name, a calendar event category, and a calendar event attendee. Next, at step 225, the embodiment further comprises activating the reminder alert in response to a missed event. Therefore in an embodiment of the invention comprising of a missed call received on a mobile telephone from a particular telephone number, a MP3/MP4 file that is configured for the particular number on the mobile telephone would be played, thereby informing a user of the mobile telephone about the missed call. Additionally, the facility of associating the MP3/MP4 file with the particular number helps the user identify the telephone number from which the user has received the missed call, or generally speaking the event source of the missed event, without viewing the details on the mobile telephone. Similarly with respect to a missed calendar event, the user would be able to identify the missed calendar event due to playing of a MP3/MP4 file that has been set for the missed calendar event.

The present invention facilitates providing a reminder for a predetermined period of time. Further, in accordance with an embodiment of the invention, the reminder could be provided continually at a predetermined time interval. The present invention also facilitates continually providing the reminder for a predetermined quantity of repetitions. Additionally, those skilled in the art would appreciate that the quantity of repetitions could also be determined by the working of the electronic device, for example, the reminder may not be repeated in case the battery of the electronic device fails.

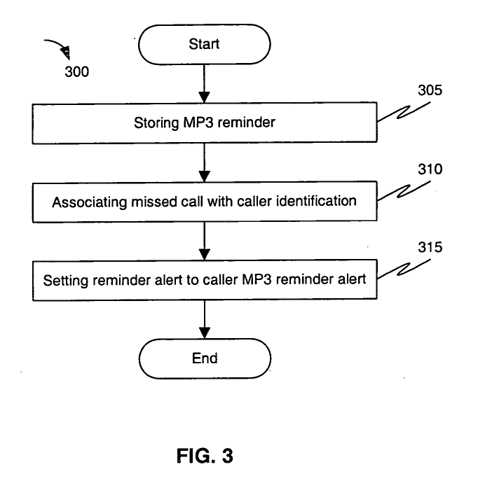

Referring to FIG. 3, an exemplary flowchart 300 of a method for enabling electronic device to provide a reminder alert for a missed event in accordance with an embodiment of the invention, wherein the missed event is a missed call. . At step 305, a caller MP3/MP4 reminder alert with a caller identification can be stored in memory 105, and further, step 310 includes associating the missed call with the caller identification. At step 315 the reminder alert can be set to the caller MP3/MP4 reminder alert. As stated above, an event source for a missed call can be selected from a group comprising a caller of the missed call, a source identification of the missed call, a telephone number of the missed call, a category of the missed call, and a category of a call source.

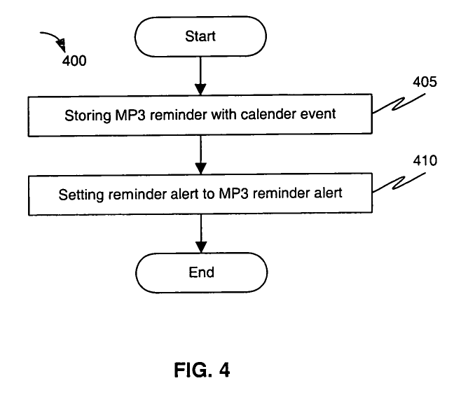

FIG. 4 illustrates an exemplary flowchart 400 of a method for enabling electronic device to provide a reminder alert for a missed event in accordance with an embodiment of the invention, wherein the missed event is a missed calendar event. As depicted in step 405, an event MP3/MP4 reminder alert can be stored with the calendar event, and thereafter as per step 410 the reminder alert can be set to the event MP3/MP4 reminder alert. As stated above, in case of the missed calendar event the event source is selected from a group comprising a calendar event organizer, a calendar event name, a calendar event category, and a calendar event attendee.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and FIGS. are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method to provide a reminder alert in an electronic device, the method comprising the steps of:
storing one or more MPEG Audio Layer 3 (MP3) or MP4 files in a memory of the electronic device;
setting a MP3/MP4 file as the reminder alert; and
activating the reminder alert in response to a missed event.

2. A method as recited in claim 1, further comprising the steps of:
selecting one of the one or more MP3/MP4 files for each of a plurality of event sources; and
associating an event source with the missed event,
wherein the reminder alert is set to the MP3/MP4 file associated with the event source.

3. A method as recited in claim 2, wherein the missed event is selected from the group comprising a missed call and a missed calendar event.

4. A method as recited in claim 2, wherein the missed event is a missed call and further wherein the event source is selected from a group comprising a caller of the missed call, a source identification of the missed call, a telephone number of the missed call, a category of the missed call, and a category of a call source.

5. A method as recited in claim 2, wherein the missed event is a missed calendar event, and further wherein the event source is selected from a group comprising a calendar event organizer, a calendar event name, a calendar event category, and a calendar event attendee.

6. A method as recited in claim 2, wherein the missed event is a missed call, the method further comprising the steps of:
storing a caller MP3/MP4 reminder alert with a caller identification in memory;
associating the missed call with the caller identification; and
setting the reminder alert to the caller MP3/MP4 reminder alert.

7. A method as recited in claim 2, wherein the missed event is a missed calendar event, the method further comprising the steps of:
storing an event MP3/MP4 reminder alert with the calendar event; and
setting the reminder alert to the event MP3/MP4 reminder alert.

8. A method as recited in claim 1 further comprising providing the reminder for a predetermined period of time.

9. The method of claim 8 further comprising continually providing the reminder at a predetermined time interval.

10. The method of claim 8 further comprising continually providing the reminder for a predetermined quantity of repetitions.

11. An electronic device comprising:
a memory for storing one or more MP3/MP4 files associated with one or more events;
a reminder module; and
a processing unit coupled with the memory and the reminder module, the processing unit adapted to:
identify a missed event;
retrieve a MP3/MP4 file associated with the missed event from the memory; and
activate a reminder alert comprising the retrieved MP3/MP4 file.

12. An electronic device as recited in claim 11, wherein the electronic device is selected from a group comprising a communication device, a mobile phone, a laptop computer, a personal computer and a personal digital assistant.

13. The device of claim 11, wherein the reminder module comprises a speaker interface, and a visual interface.
